(19) United States
(12) Patent Application Publication
(10) Pub. No.: US 2015/0252254 A1
(43) Pub. Date: Sep. 10, 2015

(54) FRACTURING SLURRY COMPOSITIONS AND METHODS FOR MAKING SAME

(71) Applicant: Trican Well Service Ltd., Calgary (CA)

(72) Inventors: Kewei Zhang, Calgary (CA); Shangying Liu, Calgary (CA); Shandong Cao, Calgary (CA)

(21) Appl. No.: 14/641,098

(22) Filed: Mar. 6, 2015

(30) Foreign Application Priority Data
Mar. 7, 2014 (CA) 2845069

(51) Int. Cl. C09K 8/80; E21B 43/267; E21B 43/25

(52) U.S. Cl. CPC C09K 8/805; E21B 43/25; E21B 43/267

(57) ABSTRACT

The present application is directed to an aqueous slurry composition for hydraulic fracturing operations and to a method of making such a composition. In particular, the present application is directed to aqueous slurry compositions comprising a liner gel that has significantly improved capability to transport proppants in a hydraulic fracturing operation. Such aqueous slurry compositions comprise an aqueous liquid, a hydrophobically modified associative polymer, proppants and a compound that renders the proppant surface hydrophobic.

### CROSS-REFERENCE TO RELATED APPLICATIONS

This application claims priority to Canadian Application No. 2,845,069, filed on Mar. 7, 2014, the entire content of which is hereby expressly incorporated herein by reference.

### FIELD OF THE INVENTION

This invention relates to an aqueous slurry composition for hydraulic fracturing operations and to a method of making such a composition.

### BACKGROUND OF THE INVENTION

Hydraulic fracturing technology is commonly used to enhance oil and gas production from a subterranean formation. A fracturing fluid is injected through a wellbore into a subterranean formation at a pressure sufficient to initiate fractures in the formation. Frequently, the fracturing fluid comprises particulates, known as proppants, suspended in the fluid and transported as a slurry into the factures. For example, after the initiation of the fractures the slurry transports the particulates into the fractures. At the last stage of the fracturing treatment, fracturing fluid flows back to the surface and proppants are left in the fracture forming a proppant pack to prevent the fracture from closing after pressure is released. Proppant-filled fractures provide highly conductive channels that allow oil and/or gas to seep through the formation to the wellbore more efficiently. The proppant-suspension capability of the fracturing fluid and the conductivity of the proppant packs formed after proppant has settled in the fractures plays a dominant role in increasing oil and gas production enhancement.

Proppants including sands, ceramic particulates, bauxite particulates, glass spheres, resin coated sands, synthetic particulates and the like are known in the industry. Among them sands are by far the most commonly used proppants.

In general, when fluids are used in subterranean operations, the nature of the subterranean formation to a large extent dictates which types of fluids are suitable for use in such operations. Fracturing fluids in common use include various water-based (i.e., aqueous) and hydrocarbon-based fluids. Due to their low cost and high versatility, water-based fluids are normally preferred and are the most commonly used fracturing fluids. To enhance the suspension capability of a fluid, it is conventional to increase fluid viscosity by adding viscosifiers, such as polymers (i.e., linear or cross-linked polymers to increase the fluids viscosity to effectively transport the proppants into the fractions in the formation). For example, a polymer such as guar gum or its derivatives, is added into an aqueous liquid where the physical entanglement of polymer chains increases the fluid viscosity and thus its suspension capability. As well, polymer chains are commonly cross-linked chemically by certain chemical compounds forming cross-linked gel, for example, guar cross-linked by borates, to further enhance fluid viscosity. Compared to the cross-linked fluid, linear gels, i.e., fluids containing sufficient amount of polymers without cross-linking, cause less formation damage, thus giving better production, and are cost-effective, but have poor suspension capability.

U.S. Pat. No. 7,723,274 teaches another manner of enhancing the suspension capability of a fluid that deviates away from focusing on the fluid's viscosity. This patent teaches enhancing the suspension of proppants in a slurry by rendering the proppant surfaces sufficiently hydrophobic to allow gas bubbles to attach to the proppant surfaces, thus increasing the buoyancy of the proppants. Because of that, the proppants can be transported into the formation effectively without requiring adding viscosifiers to the fluid. Different hydrophobising agents, such as silicone compounds, are also disclosed in U.S. Pat. No. 7,723,274.

Therefore it is highly desirable to have an aqueous slurry composition comprising a liner gel that has significantly improved capability to transport proppants in a hydraulic fracturing operation.

### SUMMARY OF THE INVENTION

According to one aspect of the present invention there is provided an aqueous fracturing slurry composition comprising an aqueous liquid, a hydrophobically modified associative polymer, proppants and a compound that renders the proppant surface hydrophobic, and the method of making such aqueous slurry composition. At the same conditions, this composition, in comparison with a fluid made with untreated proppants, has significantly improved capability of transporting proppants deep into formation in a hydraulic fracturing operation.

According to another aspect of the present invention, there is provided an aqueous fracturing slurry composition comprising an aqueous liquid, a hydrophobically modified associative polymer, and hydrophobically treated proppants, and the method of making such aqueous slurry composition.

According to a further aspect of the present invention, there is provided an aqueous fracturing slurry composition comprising an aqueous liquid, a hydrophobically modified associate polymer, proppants, a compound that renders the proppant surface hydrophobic and a gas, and the method of making such aqueous slurry composition.

The invention in another aspect relates to an aqueous fracturing slurry composition comprising an aqueous liquid, a hydrophobically modified associate polymer, hydrophobically treated proppants and a gas, and the method of making such aqueous slurry composition.

### BRIEF DESCRIPTION OF THE DRAWINGS

The embodiments of the present invention are described below with reference to the accompanying drawings in which:

FIG. 1 is a photograph of a calibrated cylinder illustrating the suspension capability of the compositions of the present invention;

FIG. 2 is a photograph of a calibrated cylinder illustrating the suspension capability of a composition using an associative polymer, but not a hydrophobising agent; and

FIG. 3 is a photograph of a calibrated cylinder illustrating the suspension capability of a composition comprising proppant pre-treated with a hydrophobising agent, but without the use of an associative polymer.

FIG. 4 is a photograph of a calibrated cylinder illustrating the suspension capability of a composition of the present invention;

FIG. 5 is a photograph of a calibrated cylinder illustrating the suspension capability of a composition comprising proppant pre-treated with a hydrophobising agent, but without the use of an associative polymer.

FIG. 6 is a photograph of a calibrated cylinder illustrating the suspension capability of a composition comprising proppant pre-treated with a hydrophobising agent, but without the use of an associative polymer.

### DETAILED DESCRIPTION OF THE INVENTION

In this application, it is found that combination of a hydrophobically modified associative polymer and a hydrophobising agent in an aqueous proppant slurry composition significantly increase the stability of the slurry composition.

Associative polymers are a relatively new class of polymers, and were introduced into oil field applications recently. Basically, these polymers consist of a hydrophilic long-chain backbone and a number of short hydrophobic groups, attached either along the long-chain or at the chain ends. When dissolved in an aqueous liquid, because of its tendency to reduce the contact between the hydrophobic groups and the surrounding water, associative polymer forms intra-molecular as well as inter-molecular associations. The associative polymers useful in the present invention include hydrophobically modified polysaccharide including hydrophobically modified guar (HMG), hydrophobically modified hydroxybutyl guar (HMHBG), hydrophobically modified polyacrylamide (HMPAM) and their derivatives.

Slurries according to the present invention can be made on the surface or in situ in a subterranean formation. Furthermore, a gas can be mixed into the slurry. Suitable gases include air, carbon dioxide, nitrogen, methane and mixtures thereof. The gas can be introduced into the slurry during preparation thereof. For example, when the slurry is pumped through a pipe, gas such as nitrogen can be introduced into the slurry.

In the present invention, “aqueous liquids” or “aqueous fluids” means water, salt solutions, water containing small amount of alcohol or other organic solvents. It should be understood that the additives other than water in the aqueous liquid are used in amounts or in a manner that does not adversely affect the ability of the fluid to be used as a fracturing fluid. The size of proppants in compositions according to the invention is generally about 10-100 US mesh, which is about 150 to 2000 μm in diameter. It should be understood that the size distribution of the proppants can be narrow or wide. Suitable proppants include sands, ceramic proppants, glass beads/spheres, bauxite proppants, resin coated sands, synthetic particulates and any other proppants known in the industry.

It is known that many organosilicon compounds including organosiloxane, organosilane, fluoro-organosiloxane and fluoro-organosilane compounds are commonly used to render various surfaces hydrophobic. For example, see U.S. Pat. Nos. 4,537,595; 5,240,760; 5,798,144; 6,323,268; 6,403,163; 6,524,597 and 6,830,811. It is normally not difficult for those skilled in the art to find suitable organosilicon compounds to render a solid surface hydrophobic. In general, organosilanes are compounds containing silicon to carbon bonds. Organosiloxanes are compounds containing Si—O—Si bonds. Polysiloxanes are compounds in which the elements silicon and oxygen alternate in the molecular skeleton, i.e., Si—O—Si bonds are repeated. The simplest polysiloxanes are polydimethylsiloxanes. Polysiloxane compounds can be modified by various organic substitutes having different numbers of carbons, which may contain N, S, or P moieties that impart desired characteristics. For example, cationic polysiloxanes are compounds in which one or more organic cationic groups are attached to the polysiloxane chain, either at the middle or the end or both at the same time. Normally the organic cationic group contains different numbers of carbons and may contain a hydroxyl group or other functional groups containing N or O. The most common organic cationic groups are organic amine derivatives including primary, secondary, tertiary and quaternary amines (for example, quaternary polysiloxanes including, quaternary polysiloxanes including mono- as well as di-quaternary polysiloxanes, amido quaternary polysiloxanes, imidazoline quaternary polysiloxanes and carboxy quaternary polysiloxanes).

Similarly, the polysiloxane can be modified by organic amphoteric groups, where one or more organic amphoteric groups are attached to the polysiloxane chain, either at the middle or the end or both, and include betaine polysiloxanes and phosphobetaine polysiloxanes.

Similarly, the polysiloxane can be modified by organic anionic groups, where one or more organic anionic groups are attached to the polysiloxane chain, either at the middle or the end or both, including sulfate polysiloxanes, phosphate polysiloxanes, carboxylate polysiloxanes, sulfonate polysiloxanes, thiosulfate polysiloxanes. The organosiloxane compounds also include alkylsiloxanes including hexamethylcyclotrisiloxane, octamethylcyclotetrasiloxane, decamethylcyclopentasiloxane, hexamethyldisiloxane, hexaethyldisiloxane, 1,3-divinyl-1,1,3,3-tetramethyldisiloxane, octamethyltrisiloxane, decamethyltetrasiloxane. The organosilane compounds include alkylchlorosilane, for example methyltrichlorosilane, dimethyldichlorosilane, trimethylchlorosilane, octadecyltrichlorosilane; alkyl-alkoxysilane compounds, for example methyl-, propyl-, isobutyl- and octyltrialkoxysilanes, and fluoro-organosilane compounds, for example, 2-(n-perfluoro-octyl)-ethyltriethoxysilane, and perfluoro-octyldimethyl chlorosilane.

Other types of chemical compounds, which are not organosilicon compounds, which can be used to render proppant surface hydrophobic are certain fluoro-substituted compounds, for example certain fluoro-organic compounds including cationic fluoro-organic compounds.

Further information regarding organosilicon compounds can be found in Silicone Surfactants (Randal M. Hill, 1999) and the references therein, and in U.S. Pat. Nos. 4,046,795; 4,537,595; 4,564,456; 4,689,085; 4,960,845; 5,098,979; 5,149,765; 5,209,775; 5,240,760; 5,256,805; 5,359,104; 6,132,638 and 6,830,811 and Canadian Patent No. 2,213,168.

Organosilanes can be represented by the formula

RₙSiX₍₄₋ₙ₎ (I)

wherein R is an organic radical having 1-50 carbon atoms that may possess functionality containing N, S, or P moieties that imparts desired characteristics, X is a halogen, alkoxy, acyloxy or amine and n has a value of 1-3. Examples of suitable organosilanes include:
CH₃SiCl₃, CH₃CH₂SiCl₃, (CH₃)₂SiCl₂, (CH₃CH₂)₂SiCl₂, (C₆H₅)₂SiCl₂, (C₆H₅)SiCl₃, (CH₃)₃SiCl, CH₃HSiCl₂, (CH₃)₂HSiCl, CH₃SiBr₃, (C₆H₅)SiBr₃, (CH₃)₂SiBr₂, (CH₃CH₂)₂SiBr₂, (C₆H₅)₂SiBr₂, (CH₃)₃SiBr, CH₃HSiBr₂, (CH₃)₂HSiBr, Si(OCH₃)₄, CH₃Si(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHCH₂Si(OCH₃)₃, (CH₃)₂Si(OCH₃)₂, (CH₂═CH)Si(CH₃)₂Cl, (CH₃)₂Si(OCH₂CH₃)₂, (CH₃)₂Si(OCH₂CH₂CH₃)₂, (CH₃)₂Si[O(CH₂)₃CH₃]₂, (CH₃CH₂)₂Si(OCH₂CH₃)₂, (C₆H₅)₂Si(OCH₃)₂, (C₆H₅CH₂)₂Si(OCH₃)₂, (C₆H₅)₂Si(OCH₂CH₃)₂, (CH₂═CH)Si(OCH₃)₂, (CH₂═CHCH₂)₂Si(OCH₃)₂, (CH₃)₃SiOCH₃, CH₃HSi(OCH₃)₂, (CH₃)₂HSi(OCH₃), CH₃Si(OCH₂CH₂CH₃)₃, CH₂═CHCH₂Si(OCH₂CH₂OCH₃)₃, (C₆H₅)₂Si(OCH₂CH₂OCH₃)₂, (CH₃)₂Si(OCH₂CH₂OCH₃)₂, (CH₂═CH)₂Si(OCH₂CH₂OCH₃)₂, (CH₂═CHCH₂)₂Si(OCH₂CH₂OCH₃)₂, (C₆H₅)₂Si(OCH₂CH₂OCH₃)₂, CH₃Si(CH₃COO)₃, 3-aminotriethoxysilane, methyldiethylchlorosilane, butyltrichlorosilane, diphenyldichiorosilane, vinyltrichiorosilane, methyltrimethoxysilane, vinyltriethoxysilane, vinyltris(methoxyethoxy)silane, methacryloxypropyltrimethoxysilane, glycidoxypropyltrimethoxysilane, aminopropyltriethoxysilane, divinyldi-2-methoxysilane, ethyltributoxysilane, isobutyltrimethoxysilane, hexyltrimethoxysilane, n-octyltriethoxysilane, dihexyldimethoxysilane, octadecyltrichlorosilane, octadecyltrimethoxysilane, octadecyldimethylchlorosilane, octadecyldimethylmethoxysilane and quaternary ammonium silanes including 3-(trimethoxysilyl)propyldimethyloctadecyl ammonium chloride, 3-(trimethoxysilyppropyldimethyloctadecyl ammonium bromide, 3-(trimethylethoxysilylpropyl)didecylmethyl ammonium chloride, triethoxysilyl soyapropyl dimonium chloride, 3-(trimethylethoxysilylpropyl)didecylmethyl ammonium bromide, 3-(trimethylethoxysilylpropyl)didecylmethyl ammonium bromide, triethoxysilyl soyapropyl dimonium bromide, (CH₃O)₃Si(CH₂)₃P⁺(C₆H₅)₃Cl, (CH₃O)₃Si(CH₂)₃P⁺(C₆H₅)₃Br⁻, (CH₃O)₃Si(CH₂)₃P⁺(CH₃)₃Cl⁻, (CH₃O)₃Si(CH₂)₃P⁺(C₆H₁₃)₃Cl⁻, (CH₃O)₃Si(CH₂)₃N⁺(CH₃)₂C₄H₉Cl, (CH₃O)₃Si(CH₂)₃N⁺(CH₃)₂CH₂C₆H₅Cl⁻, (CH₃O)₃Si(CH₂)₃N⁺(CH₃)₂CH₂CH₂OHCl⁻, (CH₃O)₃Si(CH₂)₃N⁺(C₂H₅)₃Cl⁻, (C₂H₅O)₃Si(CH₂)₃N⁺(CH₃)₂C₁₈H₃₇Cl⁻.

Among different organosiloxane compounds which are useful for the present invention, polysiloxanes modified with organic amphoteric or cationic groups including organic betaine polysiloxanes and organic quaternary polysiloxanes are examples. One type of betaine polysiloxane or quaternary polysiloxane is represented by the formula

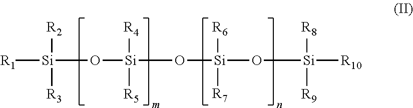

wherein each of the groups R₁ to R₆, and R₈ to R₁₀ represents an alkyl containing 1-6 carbon atoms, typically a methyl group, R₇ represents an organic betaine group for betaine polysiloxane, or an organic quaternary group for quaternary polysiloxane, and have different numbers of carbon atoms, and may contain a hydroxyl group or other functional groups containing N, P or S, and m and n are from 1 to 200. For example, one type of quaternary polysiloxanes is when R⁷ is represented by the group

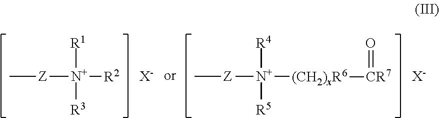

wherein R¹, R², R³ are alkyl groups with 1 to 22 carbon atoms or alkenyl groups with 2 to 22 carbon atoms. R⁴, R⁵, R⁷ are alkyl groups with 1 to 22 carbon atoms or alkenyl groups with 2 to 22 carbon atoms; R⁶ is —O— or the NR⁸ group, R⁸ being an alkyl or hydroxyalkyl group with 1 to 4 carbon atoms or a hydrogen group; Z is a bivalent hydrocarbon group, which may have a hydroxyl group and may be interrupted by an oxygen atom, an amino group or an amide group; x is 2 to 4; The R¹, R², R³, R⁴, R⁵, R⁷ may be the same or different, and X⁻ is an inorganic or organic anion including Cl⁻ and CH₃COO⁻. Examples of organic quaternary groups include [R—N⁺(CH₃)₂—CH₂CH(OH)CH₂—O—(CH₂)₃—](CH₃COO⁻), wherein R is an alkyl group containing from 1-22 carbons or an benzyl radical and CH₃COO⁻ an anion. Examples of organic betaine include —(CH₂)₃—O—CH₂CH(OH)(CH₂)—N⁺(CH₃)₂CH₂COO⁻. Such compounds are commercial available. It should be understood that cationic polysiloxanes include compounds represented by formula (II), wherein R₇ represents other organic amine derivatives including organic primary, secondary and tertiary amines.

Other example of organo-modified polysiloxanes include di-betaine polysiloxanes and di-quaternary polysiloxanes, which can be represented by the formula

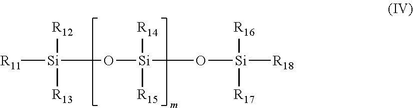

wherein the groups R₁₂ to R₁₇ each represents an alkyl containing 1-6 carbon atoms, typically a methyl group, both R₁₁ and R₁₈ group represent an organic betaine group for di-betaine polysiloxanes or an organic quaternary group for di-quaternary, and have different numbers of carbon atoms and may contain a hydroxyl group or other functional groups containing N, P or S, and m is from 1 to 200. For example, one type of di-quaternary polysiloxanes is when R₁₁ and R₁₈ are represented by the group

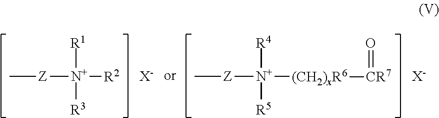

wherein R¹, R², R³, R⁴, R⁵, R⁶, R⁷, Z, X⁻ and x are the same as defined above. Such compounds are commercially available. Quaternium 80 (INCI) is one of the commercial examples.

It should be appreciated by those skilled in the art that cationic polysiloxanes include compounds represented by formula (IV), wherein R₁₁ and R₁₈ represents other organic amine derivatives including organic primary, secondary and tertiary amines. It should be apparent to those skilled in the art that there are different mono- and di-quaternary polysiloxanes, mono- and di-betaine polysiloxanes and other organo-modified polysiloxane compounds which can be used to render the solid surfaces hydrophobic and are useful in the present invention. These compounds are widely used in personal care and other products, for example as discussed in U.S. Pat. Nos. 4,054,161; 4,654,161; 4,891,166; 4,898,957; 4,933,327; 5,166,297; 5,235,082; 5,306,434; 5,474,835; 5,616,758; 5,798,144; 6,277,361, 6,482,969, 6,323,268 and 6,696,052.

Another example of organosilicon compounds which can be used in the composition of the present invention are fluoro-organosilane or fluoro-organosiloxane compounds in which at least part of the organic radicals in the silane or siloxane compounds are fluorinated, or condensation product of fluorinated silane and a polymeric compound or polymers containing both fluoro-organic groups and silyl groups. Suitable examples include fluorinated chlorosilanes or fluorinated alkoxysilanes including 2-(n-perfluoro-octyl)ethyltriethoxysilane, perfluoro-octyldimethylchlorosilane, (CF₃CH₂CH₂)₂Si(OCH₃)₂, CF₃CH₂CH₂Si(OCH₃)₃, (CF₃CH₂CH₂)₂Si(OCH₂CH₂OCH₃)₂ and CF₃CH₂CH₂Si(OCH₂CH₂OCH₃)₃ and (CH₃O)₃Sᵢ(CH₂)₃N⁺(CH₃)₂(CH₂)₃NHC(O)(CF₂)₆CF₃Cl⁻. Other compounds which can be used are fluoro-substituted compounds, which are not organic silicon compounds, for example, certain fluoro-organic compounds, including cationic fluoro-organic compounds. Another type of compound that may be used to render the surface proppants hydrophobic is organic amines including primary, secondary, tertiary amines and polyamines. Furthermore, polyisobutylene, polypropylene, poly t-butyl methacrylate, paraffin and hexatriacontane may also be used to render the surfaces hydrophobic. A person skilled in the art would also understand that mixtures and combination of the various compounds mentioned above, for example, mixtures of amine with cationic polysiloxane or mixtures of amine with other polymeric hydrophobising agents, may be used to render the surfaces of the proppants hydrophobic.

It is understood that the proppant surfaces can be hydrophobized either by forming covalent bonds between the surfaces and a hydrophobising agent or by adsorption of a hydrophobising agent on the proppant surfaces. For example, it is known that chlorosilanes and alkoxysilanes, which usually undergo hydrolysis in aqueous medium under suitable conditions, are used to modify surface through forming covalent bonds. Following hydrolysis, reactive silanol groups are formed, which can condense with other silanol groups, for example, those on the surface of siliceous materials, to form covalent bonds. For example, methyltrichlorosilane, dimethyldichlorosilane, trimethylchlorosilane, their alkoxy derivatives can be used to render glass surface hydrophobic through forming covalent bonds with the glass surfaces. It has been observed that polysiloxanes including various organic modified derivatives tend to have much less tendency to hydrolysis under normal conditions. It is believed that they modify the surfaces predominantly by adsorption on the solid surfaces. For example, it is common that solid surfaces, especially inorganic solid surfaces, in an aqueous medium possess charges, either negative or positive, which is influenced significantly by the pH of the aqueous medium. Organic substitutes on polysiloxane molecule, especially ionic ones having charges opposite to those on the solid surface, enhance significantly the adsorption of polysiloxanes on the solid surfaces. For example, a cationic polysiloxane can readily adsorb on sand surface in an aqueous liquid with neutral pH, at which the sand surface possesses negative charges. Slurries according to the present invention can be prepared, for example, by mixing an aqueous liquid, a hydrophobising agent, proppants and an associative polymer, using conventional mixing method with a sufficient amount of shear. Alternatively, the particulates can be first treated by contacting the proppants with a fluid medium containing a hydrophobising agent to render the particulate surfaces hydrophobic and then separating the proppants from the medium. The fluid medium can be a liquid or a gas. The pre-hydrophobized proppants can later be mixed with an aqueous liquid and an associative polymer to make the slurry. As well, during a hydraulic fracturing operation proppants can be first treated by contacting with a medium containing a hydrophobising agent to render their surfaces hydrophobic and subsequently the pre-hydrophobized proppants are mixed with an aqueous liquid and an associative polymer while pumping. In each case, a gas, including air, nitrogen, carbon dioxide, methane and mixtures thereof, can also be mixed into the slurry under agitation. The slurry can be prepared on surface (above ground) or in a subterranean formation where proppants, an aqueous fluid, a hydrophobising agent and an associative polymer are mixed in situ. Alternatively, in a fracturing operation the proppants can be first mixed with a liquid in which a hydrophobising agent is dispersed or dissolved and the pre-treated proppants are subsequently mixed with an aqueous fluid containing associative polymer forming the slurry and simultaneously pumped into a well. As well, in a fracturing operation the proppants can be first mixed with a liquid in which a hydrophobising agent is dispersed or dissolved and the pre-treated proppants are subsequently mixed with an aqueous fluid containing associative polymer forming the slurry and simultaneously pumped into a well and a gas, such as nitrogen, is also mixed into the slurry during pumping. Various proppants including sands and ceramic proppants can be treated according to the present invention during manufacturing process, where the proppants are treated and then transported to the well field for the fracturing operations. When used in a hydraulic fracturing operation, hydrophobising agent, for example, an amino-modified polysiloxane can be mixed with an aqueous liquid, proppants and an associative polymer on-the-fly to make the slurry and subsequently pumped into the formation during the proppant stage. Alternatively, a gas such as nitrogen is also included. With the composition of the present invention, high concentration of proppants can easily be pumped into a formation and the proppants are more evenly distributed in the fracture, leading to improved proppant conductivity. The hydrophobising agent can be added straightly or premixed with a solvent. Similarly, one can use pre-hydrophobised proppants to make the slurry while the slurry is pumped into the well during a fracturing operation. Another benefit of the slurries of the present invention is that the aqueous liquid is re-used after it is separated from the proppants after a fracturing operation. This has great significance considering there is limited water supply in the world for hydraulic fracturing operations. Finally, because of its enhanced suspension capability, the slurry composition according to the present invention is able to transport proppants in higher concentration in comparison with the conventional linear polymer fluid and thus uses less water for fracturing operations.

### EXAMPLES

The following provides non-limiting examples of the present invention. In no way should the examples be read to limit, or to define the scope of the invention.

### Example 1

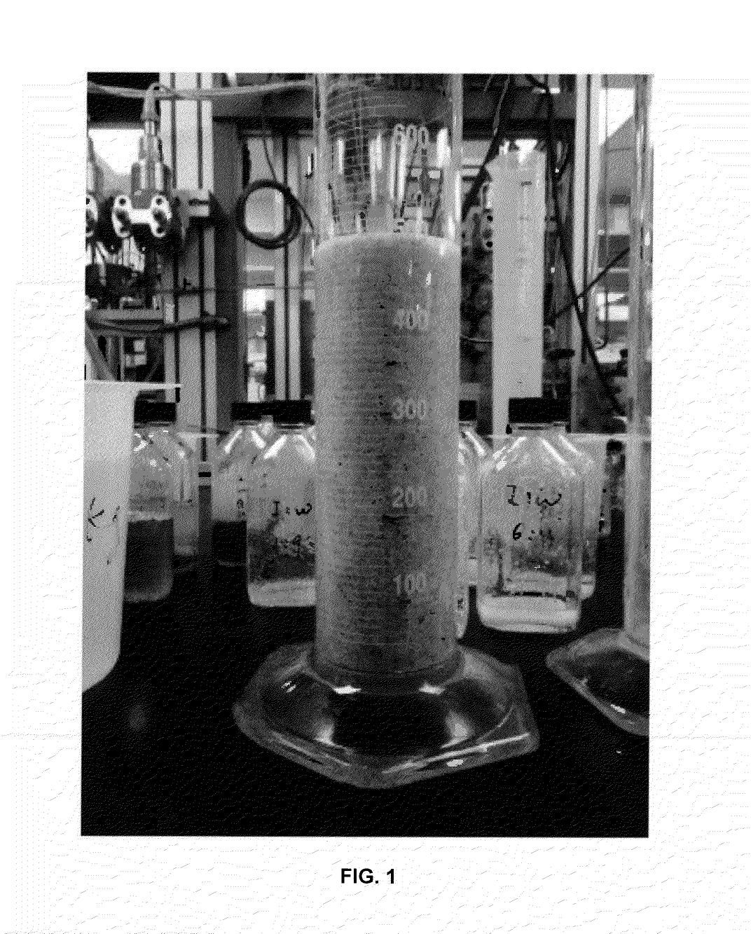

1000 g of 20/40 mesh regular frac sand was first mixed with 1000 ml of water containing 4 g of a hydrophobising agent, an amino-polysiloxane. Separating the sands from water and dried in oven at 60° C. overnight. 2.5 g associative polymer, a hydrophobically modified polyacrylamide, was dissolved into 1000 ml tap water. Taking 200 g of pre-treated sands and mixing them with 200 ml of the associative polymer solution in a laboratory blender under high agitation for 15 seconds. It was observed that about 235 ml of air was trapped in the slurry. The slurry was transferred into a calibrated cylinder. No sedimentation of the sand was observed within 30 minutes (See FIG. 1, which is an image of the slurry in the calibrated cylinder after 30 minutes).

### Example 2

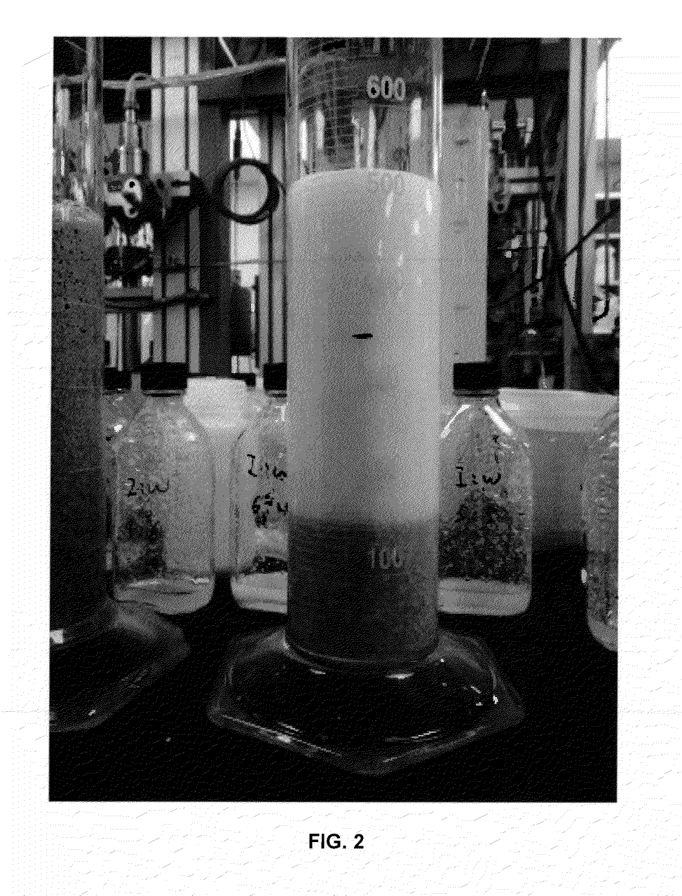

In comparison, 200 g 20/40 mesh regular frac sand and 200 ml of associative polymer, i.e., hydrophobically modified polyacrylamide, solution were mixed in the laboratory blender under high agitation for 15 seconds. It was observed that about 260 ml of air was trapped in the slurry. The slurry was transferred into a calibrated cylinder. The sand grains settled down to the bottom of the calibrated cylinder after 1 minute (See FIG. 2).

### Example 3

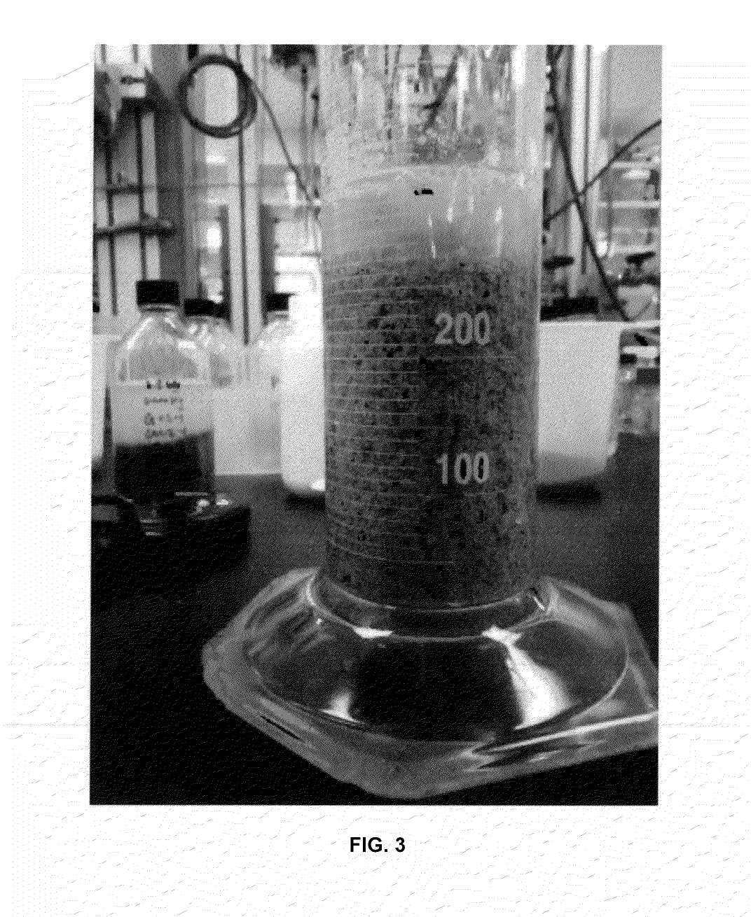

2.5 g guar powder was dissolved in 1000 ml of tap water. Taking 200 g of hydrophobically pretreated sands from Example 1 and mix them with 200 ml of the guar solution in a laboratory blender under high agitation for 15 seconds. It was observed that about 50 ml of air was trapped in the slurry. The slurry was transferred into a calibrated cylinder. Sedimentation of the sand was observed in 1 minute (See FIG. 3).

### Example 4

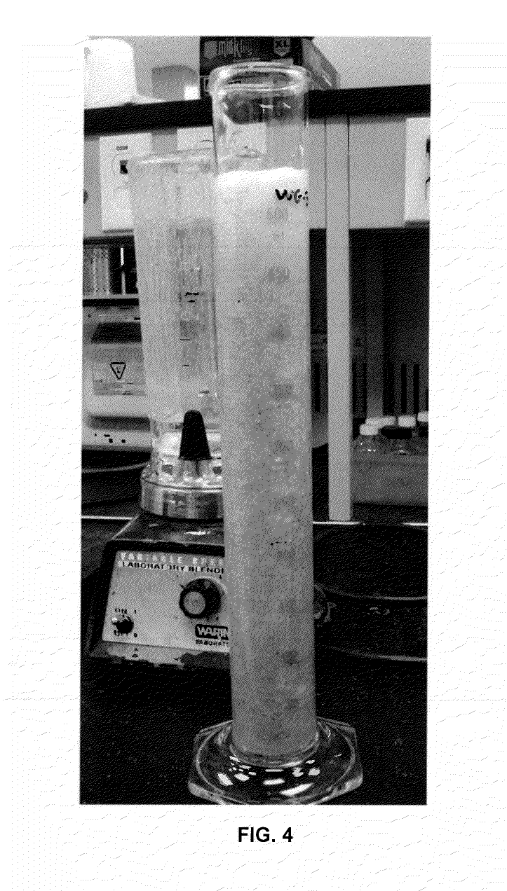

2.5 g associative polymer was dissolved in 1000 mL of tap water. 1.0 mL of 4% amino-polysiloxane in organic solvent was mixed with 200 g 20/40 mesh regular frac sand, then the coated sand was mixed with 200 mL of the associative polymer solution in a laboratory blender under high agitation for 15 seconds. It was observed that about 303 mL of air was trapped in the slurry. The slurry was transferred into a calibrated cylinder. No sedimentation of the sand was observed within 30 minutes (See FIG. 4, which is an image of the slurry in the cylinder after 30 minutes).

### Example 5

In comparison, 2.5 g guar powder was dissolved in 1000 mL of tap water. 1.0 mL of 4% amino-polysiloxane in organic solvent was mixed with 200 g 20/40 mesh regular frac sand, then the coated sand was mixed with 200 mL of the guar solution in a laboratory blender under high agitation for 15 seconds. It was observed that about 62 mL of air was trapped in the slurry. The slurry was transferred into a calibrated cylinder.

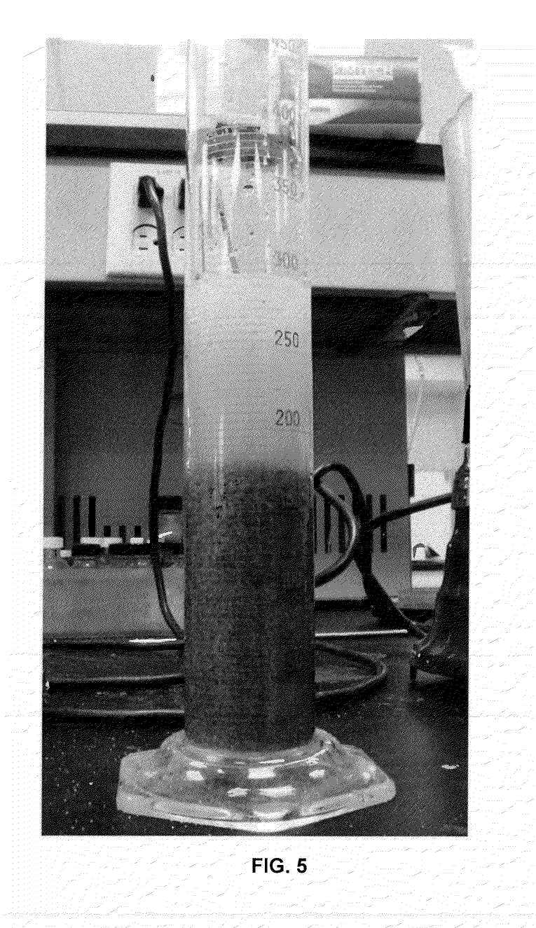

The sand grains settled down to the bottom of the calibrated cylinder within 1 minute (See FIG. 5).

### Example 6

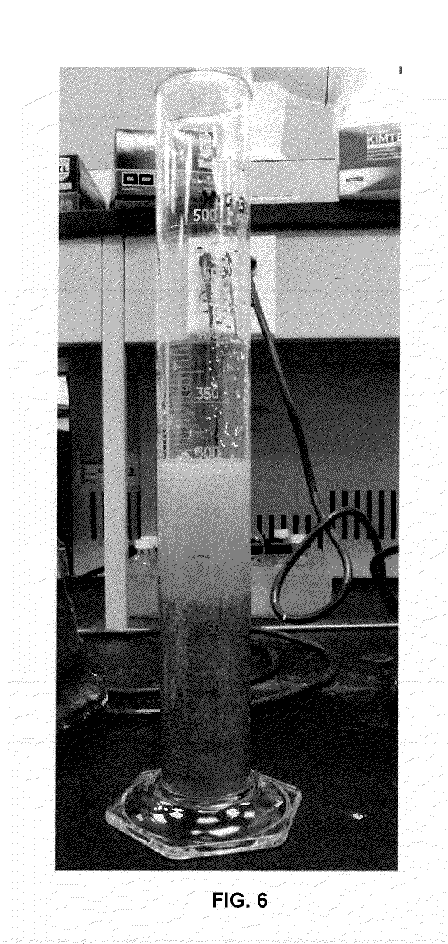

In comparison, 2.5 g carboxymethylcellulose (CMC) was dissolved in 1000 mL of tap water. 1.0 mL of 4% amino-polysiloxane in organic solvent was mixed with 200 g 20/40 mesh regular frac sand, then the coated sand was mixed with 200 mL of the CMC solution in a laboratory blender under high agitation for 15 seconds. It was observed that about 46 mL of air was trapped in the slurry. The slurry was transferred into a calibrated cylinder. The sand grains settled down to the bottom of the calibrated cylinder within 1 minute (See FIG. 6).

What is claimed is:

1. A method of preparing a hydraulic fracturing slurry composition comprising the steps of mixing together:
a) an aqueous liquid;
b) proppants;
c) a hydrophobising agent for rendering the surface of the proppants hydrophobic; and
d) an associative polymer.

2. The method according to claim 1, wherein the proppants are selected from the group consisting of: sand, resin coated sand, ceramic, bauxite, glass spheres, and combinations thereof.

3. The method according to claim 1, wherein the method of preparing the hydraulic fracturing slurry composition includes the step of pumping the slurry composition into a subterranean formation during a hydraulic fracturing operation.

4. The method according to claim 3, wherein the associative polymer is selected from the group consisting of: hydrophobically modified guar (HMG), hydrophobically modified hydroxybutyl guar (HMHBG), their derivatives and combinations thereof.

5. The method according to claim 1, wherein the associative polymer is hydrophobically modified polyacrylamide (HMPAM).

6. The method according to any one of claim 1, wherein the hydrophobising agent is selected from the group consisting of: organic amines, organosilane, organosiloxane, a fluoro-organosilane, a fluoro-organosiloxane, a fluoro-organic compound and combinations thereof.

7. The method according to claim 6, wherein the hydrophobising agent is an organosilane having the formula:
RₙSiX₍₄₋ₙ₎
wherein R is an organic radical having 1-50 carbon atoms, X is a halogen, alkoxy, acyloxy or amine and n has a value of 1-3.

8. The method according to claim 6, wherein the organosilane is selected from the group consisting of:
CH₃SiCl₃, CH₃CH₂SiCl₃, (CH₃)₂SiCl₂, (CH₃CH₂)₂SiCl₂, (C₆H₅)₂SiCl₂, (C₆H₅)SiCl₃, (CH₃)₃SiCl, CH₃HSiCl₂, (CH₃)₂HSiCl, CH₃SiBr₃, (C₆H₅)SiBr₃, (CH₃)₂SiBr₂, (CH₃CH₂)₂SiBr₂, (C₆H₅)₂SiBr₂, (CH₃)₃SiBr, CH₃HSiBr₂, (CH₃)₂HSiBr, Si(OCH₃)₄, CH₃Si(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHCH₂Si(OCH₃)₃, (CH₃)₂Si(OCH₃)₂, (CH₂═CH)Si(CH₃)₂Cl, (CH₃)₂Si(OCH₂CH₃)₂, (CH₃)₂Si(OCH₂CH₂CH₃)₂, (CH₃)₂Si[O(CH₂)₃CH₃]₂, (CH₃CH₂)₂Si(OCH₂CH₃)₂, (C₆H₅)₂Si(OCH₃)₂, (C₆H₅CH₂)₂Si(OCH₃)₂, (C₆H₅)₂Si(OCH₂CH₃)₂, (CH₂═CH)Si(OCH₃)₂, (CH₂═CHCH₂)₂Si(OCH₃)₂, (CH₃)₃SiOCH₃, CH₃HSi(OCH₃)₂, (CH₃)₂HSi(OCH₃), CH₃Si(OCH₂CH₂CH₃)₃, CH₂═CHCH₂Si(OCH₂CH₂OCH₃)₃, (C₆H₅)₂Si(OCH₂CH₂OCH₃)₂, (CH₃)₂Si(OCH₂CH₂OCH₃)₂, (CH₂═CH)₂Si(OCH₂CH₂OCH₃)₂, (CH₂═CHCH₂)₂Si(OCH₂CH₂OCH₃)₂, (C₆H₅)₂Si(OCH₂CH₂OCH₃)₂, CH₃Si(CH₃COO)₃, 3-aminotriethoxysilane, methyldiethylchlorosilane, butyltrichlorosilane, diphenyldichlorosilane, vinyltrichlorosilane, methyltrimethoxysilane, vinyltriethoxysilane, vinyltris(methoxyethoxy)silane, methacryloxypropyltrimethoxysilane, glycidoxypropyltrimethoxysilane, aminopropyltriethoxysilane, divinyldi-2-methoxysilane, ethyltributoxysilane, isobutyltrimethoxysilane, hexyltrimethoxysilane, n-octyltriethoxysilane, dihexyldimethoxysilane, octadecyltrichlorosilane, octadecyltrimethoxysilane, octadecyldimethylchlorosilane, octadecyldimethylmethoxysilane and quaternary ammonium silanes including 3-(trimethoxysilyl)propyldimethyloctadecyl ammonium chloride, 3-(trimethoxysilyppropyldimethyloctadecyl ammonium bromide, 3-(trimethylethoxysilylpropyl)didecylmethyl ammonium chloride, triethoxysilyl soyapropyl dimonium chloride, 3-(trimethylethoxysilylpropyl)didecylmethyl ammonium bromide, 3-(trimethylethoxysilylpropyl)didecylmethyl ammonium bromide, triethoxysilyl soyapropyl dimonium bromide, (CH₃O)₃Si(CH₂)₃P⁺(C₆H₅)₃Cl, (CH₃O)₃Si(CH₂)₃P⁺(C₆H₅)₃Br⁻, (CH₃O)₃Si(CH₂)₃P⁺(CH₃)₃Cl⁻, (CH₃O)₃Si(CH₂)₃P⁺(C₆H₁₃)₃Cl⁻, (CH₃O)₃Si(CH₂)₃N⁺(CH₃)₂C₄H₉Cl, (CH₃O)₃Si(CH₂)₃N⁺(CH₃)₂CH₂C₆H₅Cl⁻, (CH₃O)₃Si(CH₂)₃N⁺(CH₃)₂CH₂CH₂OHCl⁻, (CH₃O)₃Si(CH₂)₃N⁺(C₂H₅)₃Cl⁻, (C₂H₅O)₃Si(CH₂)₃N⁺(CH₃)₂C₁₈H₃₇Cl⁻ and combinations thereof.

9. The method according to claim 6, wherein the hydrophobising agent is a polysiloxanes modified with organic amphoteric or cationic groups.

10. The method according to claim 6, wherein the hydrophobising agent is an organic amphoteric polysiloxane.

11. The method according to claim 6, wherein the hydrophobising agent is an organosiloxane having the formula: 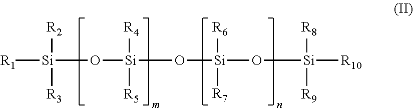
wherein each of the groups R₁ to R₆ and R₈ to R₁₀ represents an alkyl containing 1-6 carbon atoms, R₇ represents an organic betaine group for betaine polysiloxane, or an organic quaternary group for quaternary polysiloxane, and have different numbers of carbon atoms, and m and n are from 1 to 200.

12. The method according to claim 11, wherein R₇ represents an organic amine derivative including primary, secondary, tertiary and quaternary amine groups.

13. The method according to claim 11, wherein the hydrophobising agent is a quaternary polysiloxane wherein R₇ is represented by the following formula: 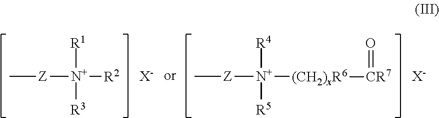
wherein R¹, R², R³ are alkyl groups with 1 to 22 carbon atoms or alkenyl groups with 2 to 22 carbon atoms;
R⁴, R⁵, R⁷ are alkyl groups with 1 to 22 carbon atoms or alkenyl groups with 2 to 22 carbon atoms;
R⁶ is —O— or the NR⁸ group;
R⁸ being an alkyl or hydroxyalkyl group with 1 to 4 carbon atoms or a hydrogen group;
Z is a bivalent hydrocarbon group, which may have a hydroxyl group and may be interrupted by an oxygen atom, an amino group or an amide group;
x is 2 to 4; and
wherein R¹, R², R³, R⁴, R⁵, R⁷ may be the same or different compounds and X⁻ is an inorganic or organic anion.

14. The method according to claim 6, wherein the hydrophobising agent is an organo-modified polysiloxane according to the following formula: 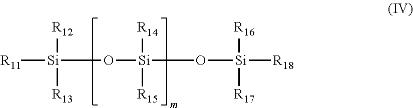
wherein the groups R₁₂ to R₁₇ each represents an alkyl containing 1-6 carbon atoms; both R₁₁ and R₁₈ group represent an organic betaine group for di-betaine polysiloxanes or an organic quaternary group for di-quaternary, and m is from 1 to 200.

15. The method according to claim 14, wherein the hydrophobising agent is a di-quaternary polysiloxane R₁₁ and R₁₈ are represented by the following: 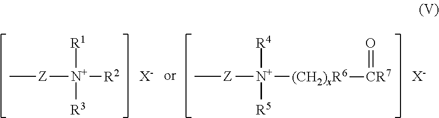
wherein R¹, R², R³ are alkyl groups with 1 to 22 carbon atoms or alkenyl groups with 2 to 22 carbon atoms;
R⁴, R⁵, R⁷ are alkyl groups with 1 to 22 carbon atoms or alkenyl groups with 2 to 22 carbon atoms;
R⁶ is —O— or the NR⁸ group;
R⁸ being an alkyl or hydroxyalkyl group with 1 to 4 carbon atoms or a hydrogen group;
Z is a bivalent hydrocarbon group, which may have a hydroxyl group and may be interrupted by an oxygen atom, an amino group or an amide group;
x is 2 to 4; and
wherein R¹, R², R³, R⁴, R⁵, R⁷ may be the same or different compounds and X⁻ is an inorganic or organic anion.

16. The method according to claim 14 wherein R₁₁ and R₁₈ represent organic amine derivatives including organic primary, secondary and tertiary amine groups.

17. The method according to claim 1, wherein the method includes the step of subjecting the slurry composition to shear in the presence of a gas;
wherein the gas is selected from the group consisting of: air, nitrogen, carbon dioxide, methane and mixtures thereof.

18. The method according to claim 17, wherein the gas is nitrogen or carbon dioxide.

19. A method of preparing a hydraulic fracturing slurry composition comprising the steps of:
a) contacting proppants with medium containing a hydrophobising agent for rendering the surface of the proppants hydrophobic;
b) separating the medium from the proppants;
c) mixing the proppants with an aqueous liquid and an associative polymer, and
d) pumping the slurry into a subterranean formation during a hydraulic fracturing operation.

20. The method according to claim 19, wherein the associative polymer is selected from the group consisting of: hydrophobically modified guar (HMG), hydrophobically modified hydroxybutyl guar (HMHBG), their derivatives and combinations thereof.

21. The method according to claim 19, wherein the associative polymer is hydrophobically modified polyacrylamide (HMPAM).

22. The method according to claim 19, wherein the hydrophobising agent is selected from the group consisting of organic amines, organosilane, organosiloxane, a fluoro-organosilane, a fluoro-organosiloxane, a fluoro-organic compound and combinations thereof.

23. The method according to claim 22, wherein the hydrophobising agent is an organosilane having the formula:
RₙSiX₍₄₋ₙ₎
wherein R is an organic radical having 1-50 carbon atoms, X is a halogen, alkoxy, acyloxy or amine and n has a value of 1-3.

24. The method according to claim 22, wherein the organosilane is selected from the group consisting of:
CH₃SiCl₃, CH₃CH₂SiCI₃, (CH₃)₂SiCl₂, (CH₃CH₂)₂SiCl₂, (C₆H₅)₂SiCl₂, (C₆H₅)SiCI₃, (CH₃)₃SiCl, CH₃HSiCl₂, (CH₃)₂HSiCl, CH₃SiBr₃, (C₆H₅)SiBr₃, (CH₃)₂SiBr₂, (CH₃CH₂)₂SiBr₂, (C₆H₅)₂SiBr₂, (CH₃)₃SiBr, CH₃HSiBr₂, (CH₃)₂HSiBr, Si(OCH₃)₄, CH₃Si(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHCH₂Si(OCH₃)₃, (CH₃)₂Si(OCH₃)₂, (CH₂═CH)Si(CH₃)₂Cl, (CH₃)₂Si(OCH₂CH₃)₂) (CH₃)₂Si(OCH₂CH₂CH₃)₂, (CH₃)₂Si[O(CH₂)₃CH₃]₂, (CH₃CH₂)₂Si(OCH₂CH₃)₂, (C₆H₅)₂Si(OCH₃)₂, (C₆H₅CH₂)₂Si(OCH₃)₂, (C₆H₅)₂Si(OCH₂CH₃)₂, (CH₂═CH)Si(OCH₃)₂, (CH₂═CHCH₂)₂Si(OCH₃)₂, (CH₃)₃SiOCH₃, CH₃HSi(OCH₃)₂, (CH₃)₂HSi(OCH₃), CH₃Si(OCH₂CH₂CH₃)₃, CH₂═CHCH₂Si(OCH₂CH₂OCH₃)₃, (C₆H₅)₂Si(OCH₂CH₂OCH₃)₂, (CH₃)₂Si(OCH₂CH₂OCH₃)₂, (CH₂═CH₂)₂Si(OCH₂CH₂OCH₃)₂, (CH₂═CHCH₂)₂Si(OCH₂CH₂OCH₃)₂, (C₆H₅)₂Si(OCH₂CH₂OCH₃)₂, CH₃Si(CH₃COO)₃, 3-aminotriethoxysilane, methyldiethylchlorosilane, butyltrichlorosilane, diphenyldichlorosilane, vinyltrichlorosilane, methyltrimethoxysilane, vinyltriethoxysilane, vinyltris(methoxyethoxy)silane, methacryloxypropyltrimethoxysilane, glycidoxypropyltrimethoxysilane, aminopropyltriethoxysilane, divinyldi-2-methoxysilane, ethyltributoxysilane, isobutyltrimethoxysilane, hexyltrimethoxysilane, n-octyltriethoxysilane, dihexyldimethoxysilane, octadecyltrichlorosilane, octadecyltrimethoxysilane, octadecyldimethylchlorosilane, octadecyldimethylmethoxysilane and quaternary ammonium silanes including 3-(trimethoxysilyl)propyldimethyloctadecyl ammonium chloride, 3-(trimethoxysilyl)propyldimethyloctadecyl ammonium bromide, 3-(trimethylethoxysilylpropyl)didecylmethyl ammonium chloride, triethoxysilyl soyapropyl dimonium chloride, 3-(trimethylethoxysilylpropyl)didecylmethyl ammonium bromide, 3-(trimethylethoxysilylpropyl)didecylmethyl ammonium bromide, triethoxysilyl soyapropyl dimonium bromide, (CH₃O)₃Si(CH₂)₃P⁺(C₆H₅)₃Cl, (CH₃O)₃Si(CH₂)₃P⁺(C₆H₅)₃Br⁻, (CH₃O)₃Si(CH₂)₃P⁺(CH₃)₃Cl⁻, (CH₃O)₃Si(CH₂)₃P⁺(C₆H₁₃)₃Cl⁻, (CH₃O)₃Si(CH₂)₃N⁺(CH₃)₂C₄H₉Cl, (CH₃O)₃Si(CH₂)₃N⁺(CH₃)₂CH₂C₆H₅Cl⁻, (CH₃O)₃Si(CH₂)₃N⁺(CH₃)₂CH₂CH₂OHCl⁻, (CH₃O)₃Si(CH₂)₃N⁺(C₂H₅)₃Cl⁻, (C₂H₅O)₃Si(CH₂)₃N⁺(CH₃)₂C₁₈H₃₇Cl⁻ and combinations thereof.

25. The method according to claim 22, wherein the hydrophobising agent is a polysiloxanes modified with organic amphoteric or cationic groups.

26. The method according to claim 22, wherein the hydrophobising agent is an organic amphoteric polysiloxane.

27. The method according to claim 22, wherein the hydrophobising agent is an organosiloxane having the formula: 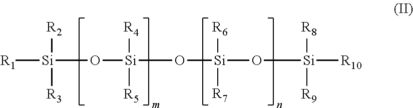
wherein each of the groups R₁ to R₆ and R₈ to R₁₀ represents an alkyl containing 1-6 carbon atoms, R₇ represents an organic betaine group for betaine polysiloxane, or an organic quaternary group for quaternary polysiloxane, and have different numbers of carbon atoms, and m and n are from 1 to 200.

28. The method according to claim 27, wherein R₇ represents an organic amine derivative including primary, secondary, tertiary and quaternary amine groups.

29. The method according to claim 27, wherein the hydrophobising agent is a quaternary polysiloxane wherein R₇ is represented by the following formula: 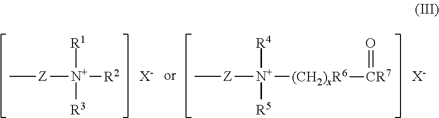
wherein R¹, R², R³ are alkyl groups with 1 to 22 carbon atoms or alkenyl groups with 2 to 22 carbon atoms;
R⁴, R⁵, R⁷ are alkyl groups with 1 to 22 carbon atoms or alkenyl groups with 2 to 22 carbon atoms;
R⁶ is —O— or the NR⁸ group;
R⁸ being an alkyl or hydroxyalkyl group with 1 to 4 carbon atoms or a hydrogen group;
Z is a bivalent hydrocarbon group, which may have a hydroxyl group and may be interrupted by an oxygen atom, an amino group or an amide group;
x is 2 to 4; and
wherein R¹, R², R³, R⁴, R⁵, R⁷ may be the same or different compounds and X⁻ is an inorganic or organic anion.

30. The method according to claim 22, wherein the hydrophobising agent is an organo-modified polysiloxane according to the following formula: 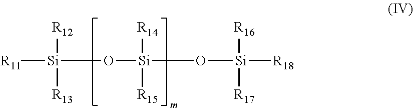
wherein the groups R₁₂ to R₁₇ each represents an alkyl containing 1-6 carbon atoms; both R₁₁ and R₁₈ group represent an organic betaine group for di-betaine polysiloxanes or an organic quaternary group for di-quaternary, and m is from 1 to 200.

31. The method according to claim 30, wherein the hydrophobising agent is a di-quaternary polysiloxane R₁₁ and R₁₈ are represented by the following: 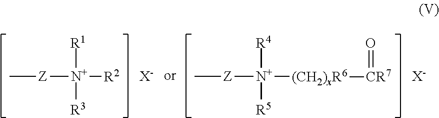
wherein R¹, R², R³ are alkyl groups with 1 to 22 carbon atoms or alkenyl groups with 2 to 22 carbon atoms;
R⁴, R⁵, R⁷ are alkyl groups with 1 to 22 carbon atoms or alkenyl groups with 2 to 22 carbon atoms;
R⁶ is —O— or the NR⁸ group;
R⁸ being an alkyl or hydroxyalkyl group with 1 to 4 carbon atoms or a hydrogen group;
Z is a bivalent hydrocarbon group, which may have a hydroxyl group and may be interrupted by an oxygen atom, an amino group or an amide group;
x is 2 to 4; and
wherein R¹, R², R³, R⁴, R⁵, R⁷ may be the same or different compounds and X⁻is an inorganic or organic anion.

32. The method according to claim 30 wherein R₁₁ and R₁₈ represent organic amine derivatives including organic primary, secondary and tertiary amine groups.

33. The method according to claim 19, wherein the method includes the step of subjecting the slurry composition to shear in the presence of a gas;
wherein the gas is selected from a group consisting of air, nitrogen, carbon dioxide, methane and mixtures thereof.

34. The method according to claim 33, wherein the gas is nitrogen or carbon dioxide.

35. A method of hydraulic fracturing comprising the steps of preparing and deploying a hydraulic fracturing slurry composition prepared according to the steps of claim 1.

36. A method of hydraulic fracturing comprising the steps of preparing and deploying a hydraulic fracturing slurry composition prepared according to the steps of claim 19.
